(19) United States
(12) Patent Application Publication
(10) Pub. No.: US 2002/0141734 A1
(43) Pub. Date: Oct. 3, 2002

(54) Method of making video program

(76) Inventors: Shigeyuki Murata, Koganei (JP); Hirotada Ueda, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/103,817

(22) Filed: Mar. 25, 2002

(30) Foreign Application Priority Data
Mar. 27, 2001 (JP) 2001-089910

(51) Int. Cl. H04N 5/92

(52) U.S. Cl. 386/46; 386/69; 386/125

(57) ABSTRACT

Method of making a video program, wherein data about at least individual names, shapes and motions in connection with at least two objects appearing on the video program is recorded in a recording device; one of the objects is an image source material of the video program, and the other object is a phantom image source material of the video program; in making the video program, the object used in said video program is designated, data relating to the objects is read out from the recording device; and the video program is then made based on the data read out from the recording device.

### CROSS-REFERENCE TO RELATED APPLICATION

The present application relates to subject matters described in a co-pending application Ser. No. 09/689,799 filed on Oct. 13, 2000 assigned to the assignee of the present application. The disclosures of this application are incorporated herein by reference.

### BACKGROUND OF THE INVENTION

The present invention relates to techniques of making a video program by using a computer, and more particularly to a video image creating method suitable for creating animation images by computer graphics.

Developments on image creating systems using computers to make a television program by using animation images (moving images) through computer graphics (hereinafter described as “CG”) have recently been made vigorously. Several CG animation images created by such systems are broadcast nowadays. In creasing CG animation images, voice synthesizing techniques, moving image reproducing techniques and the like are utilized to realize highly sophisticated images.

Graphical user interface (GUI) for interactive communications between a computer and a person via icons on a display screen is becoming usual mainly in the field of personal computers. GUI is essential techniques for image creation. A program making system is now practically used which has GUI allowing a creator or an editor to make a television program as if the creator writes a scenario (film script).

A TV program Making Language (TVML) has been developed recently which is a dedicated language for creating CG animation images. TVML is described in “TVML (TV program Making Language)—Automatic TV Program Generation from Text-based Script-” by Hayashi, et al., publicized in internet web cite http://www.strl.nhk.or.jp/TVML/indexj.html provided by the Japan Broadcasting Corp. TVML is a text-based language which can describe elements necessary for making a TV program in the form of scripts and assumes the incorporation of GUI operations.

Images are created by using TVML as in the following. Image source materials, i.e., CG objects, are prepared. CG objects include various characters (humans), studio sets, properties, lighting, titles and the like as well as prerecorded voices (speeches, bird notes and the like), moving images and the like. CG objects are selected in accordance with the contents of a program, and each (prepared as an event) of actions (e.g, in the case of a character, speak, bow, walk, and etc.) of each CG object is written one script row after another. During the creation process through writing, GUI operations are used for display screen operations to create CG animation images.

A TV program making apparatus utilizing TVML has: a main storage unit for storing images of various objects (image source materials) and images obtained during the creation process; an animation creating unit for creating animation of each selected object; a memory for storing each adopted event; a voice synthesizing unit for synthesizing speech voices of each character; a moving image generating unit for reproducing moving images; a mouse and keyboard for GUI operations; a central processing unit (CPU) for controlling each unit described above, and the like.

With reference to FIGS. 5 to 7, an example of CG animation to be created by the TV program making apparatus will be described in which two characters come on a studio set.

FIG. 7 is a diagram showing an example of an edit window for making a TV program in a manner like writing a scenario. In FIG. 7, reference numeral 201 represents an edit window, 208 represents a monitor window, 212 represents a studio setup button, 301 represents a studio setup window, 302 represents a setting mode select menu box for switching between a character setting mode, a camera setting mode and a property setting mode, 303 represents an add button for adding a character to a studio set, 304 represents a studio set select menu box for changing a studio set of CG. 305 represents a default button for initializing a value such as a layout of a CG object, 306 represents a cancel button for returning to the state before edition, 307 represents a close button for ending a studio setup (closing a display of the studio setup window), 308 represents a character board, 309 represents a name edit text field, 310 represents a model selection menu, 311 represents a voice quality menu, 312 represents a layout x text field, 313 represents a layout z text field, 314 represents a direction d text field, and 315 represents a state select menu field. In the following, setting the layout of characters will be described by way of example.

Referring to FIG. 7, as the studio setup button 212 is clicked (GUI operation) by a pointing device such as a mouse, the studio setup window 301 is activated and displayed on the edit window 201.

In the displayed studio setup window 301, the character board 308 is constituted of: a name edit text field 309 for editing the name of a character; a model select menu 310 for selecting the type of the character; a voice quality menu 311 for selecting the type of words spoken by the character; a layout x text field 312 for indicating the x-coordinate position of the character in a studio set; a layout z text field 313 for indicating the z-coordinate position; a direction d text field 314 for indicating the direction of the character; and a state select menu 315 for selecting either a standing state or a sitting state. The character board 308 can be displayed as many as the number of characters appearing on the program to be edited. For example, by depressing the character add button 303, a new character board is displayed under the character board 308 shown in FIG. 7 and at the same time, the studio set select menu 304, default button 305, cancel button 306 and close button 307 are displayed being shifted below. If all windows cannot be displayed in the whole screen area of the monitor 8, only those areas capable of being displayed are displayed. If all windows cannot be displayed, an editor operates a GUI figure such as a slide displayed on the screen to scroll the screen to display a window to be viewed (to be operated).

In the coordinate system of the studio set, the width direction as viewed from the front side of the studio set is an x-axis (+ in the right direction), the height direction is a y-axis (+ in the up direction), the depth direction is a z-axis (+ in the front direction), and the center of the floor (x-z plane) of the studio set is an origin. The front side of the studio set corresponds to a view point direction displayed in the monitor window shown in FIG. 7. Two characters are displayed on the monitor window 208.

FIG. 6 is a diagram showing only the monitor window 208 derived from FIG. 7.

The right screen side 251 shows a character having a character name “BOB” which uses a model named “YOUNG MAN”. The model determines the appearance, shape and motion of the character. In making a video program using TVML, a plurality type of models are generally prepared beforehand in a memory of a computer. A user can set a model proper to a character of the program by designating the model name of the model. By setting the model name to the model select menu box 310 by using an input unit 9 (FIG. 1), it is possible to set the gender, face, clothing, posture, motion available in images, respectively of the character. If the model name is not set, a specific shape does not exist and cannot be displayed on the screen. The left screen side 252 shows a character having a character name “MARY” which uses a model named “YOUNG WOMAN”. The character names “BOB” and “MARY” are unique to the characters of the program, i.e., unique names. A model of a young male animation character having the same model name “YOUNG MAN” can be applied to different character names, e.g., “BOB” and JIM”, or different models can be set. A model is prepared in order to set not only each character, but also each of properties, backgrounds as well as each shape, color and motion of each CG object such as an animal. To properties, backgrounds and other CG objects such as animals, unique names of CG objects corresponding to character names are set. An animation image of each CG object is determined from the unique name and model name. There may be provided various different models in the various moving picture editing systems used for the TVML edition and reproduction of the program. The moving picture editing system is an apparatus for carrying out the TVML edition under the control by a software (a program) such as a computer having a CPU.

It is also possible to set animation images of insects, for example, BEETLE (model name) having the character names “beetle 1”, “beetle 2” and “beetle 3” and the same shape, size and color.

An example of the process of newly generating program data (scripts executable to reproduce a program) by activating the TV program making apparatus, or reading already existing program data and editing it, will be described.

A program making process for two characters “BOB” and “MARY” shown in FIG. 6 will be described with reference to FIG. 5.

In the process of making or editing program data to be performed by the TV program making apparatus, it is first checked whether the entering character name is set (Step 401) as shown in FIG. 5. This setting corresponds to that as described with FIG. 7, an editor enters the character name in the name box 309 on the screen 301. As the character name is entered, a character data structure to be managed by the program making apparatus is generated (Step 402). This character management data structure is represented by a data table which describes various data setting items in the character board 308 of the studio setup window 301 shown in FIG. 7 in correspondence with each character name. FIG. 8A is a schematic diagram showing an example of the character management data structure. This character management data structure 80 includes: a box 81 for writing a character name; a button 82 for writing a model name of a model used by the character; and other boxes 83 for writing the coordinate values x and y and direction d of the character in the studio, the voice type of the character, the posture of the character and the like. For example, during the execution of a CG animation program making program, the character management data structure 80 is referred to by using the character name “BOB” to use the data set to each box of the data structure 80, so that the character “BOB” enters the CG animation image. The character management data structure created at Step 402 has empty character name and model name boxes 81 and 82 and default initial values in other boxes 83. If the character name is entered in the name box 309 of the character board 308, the input character name is written in the character name box 81 of the character management data structure 80 (Step 403). At this time, since it is not known which model is used, the model name box 82 is maintained empty (Step 404).

Next, it is checked whether the model name used by the character is set to the box 309 of the character board 308 (Step 405). If the model name is set, the set model name is written in the model name box 82 of the data structure 80 (Step 406).

In this example, two data structures 80 corresponding to two characters are generated for managing entering characters. “BOB” and “YOUNG MAN” are written in the character name box and model name box of one data structure, whereas “MARY” and “YOUNG WOMAN” are written in the character name box and model name box of the other data structure.

If two characters are to be entered and the character names of two characters are set although one model name is not set, then this model name of one character is not written in the character management data structure.

For example, it is assumed that two data structures for managing the entering characters are generated, and that “BOB” and “YOUNG MAN” are written in the character name box and model name box of one data structure, and that “MARY” is written in the character box of the other data structure and “YOUNG WOMAN” is not written in the character name box. In this state, if a CG animation program is created and scripts are executed in order to confirm the created contents, although the character on the screen right side is displayed, the character on the screen left side is not displayed because the model name of “MARY” is not known.

It may occur that the model name of one character is input erroneously, for example, “YOUNG MAN” is input erroneously as “YOUNG”. In this case, even if scripts are executed, the erroneous part cannot be executed so that reproduction stops at this part.

In the above examples, a creator or an editor “forgets” to set the model name or “erroneously sets” the model name. In addition to such examples, other various cases may occur. For example, a model is not still generated at the time of creation or a model name cannot be determined at the time of creation.

### SUMMARY OF THE INVENTION

As described above, if the user forgets to set the model name of a character or CG object, the CG object is not displayed as an image on the display screen. In addition to forgetting to set the model name, there are many other reasons why the CG object is not displayed. For example, a model name of another CG object is erroneously set, the name of a CG object is not set, the position of an entering CG object is wrong, a set model does not exist in the apparatus, an application itself is not operating, and etc.

In order to check the reason why a CG object is not displayed or reproduced, it is necessary to perform some works of checking the creation steps one after another in the reverse order. In this case, a program creation efficiency lowers inevitably.

A created program is displayed in some case by another apparatus difference from that used for making the program. In such a case, if a usable model registered in the apparatus used for making the program does not exist in another apparatus (not registered), the CG object cannot be displayed. The user is required to check the reason with some labor. If the other apparatus is operated by another user, there is a danger that the user supposes that the CG object does not exist initially.

It is an object of the present invention to provide a video program making method capable of easily check the reason why a CG object is not displayed on the screen.

A video program making method of the invention achieving the above object is configured as in the following. Data about at least unique name, shapes and motions in connection with at least two objects appearing on the video program is recorded in a recording device. At least one of the objects is an image source material of the video program, and the other object is a false image source material of the video program. In making the video program, the object used in said video program is designated. The data about at least two objects is read out from the recording device. The video program is then made based on the data read out from the recording device.

Even if there is a CG object whose model name is not designated or even if a designated model name is not still registered, i.e., even if an erroneous model name is designated, a preset specific false model different from a usual model of a CG object is used. Accordingly, it will not occur that the CG animation program displays no CG object or reproduces no CG object. Therefore, the user can notice the false model in the reproduced image or the display screen. The user can judge that the reason is none of those cases wherein the name of a CG object is not set, the position of an entering CG object is wrong, and the application itself is not operating. The remaining reason is one of those cases wherein the model name was not written, an erroneous model name was set, and the set model does not exist in the apparatus. In this manner, the reason can be checked easily. Furthermore, there is no danger that the user supposes that the CG object does not exist initially.

If the model to be used cannot be determined at the time of CG object setting, the CG object having the preset model name is displayed during creation of a CG animation program. It becomes therefore easy to change later the model name.

According to the present invention, a program making efficiency can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a TV program making apparatus to be used with a video program making method according to an embodiment of the invention.

FIG. 2 is a flow chart illustrating the concept of the video program making method of the embodiment.

FIG. 3 is a flow chart illustrating the video program making method of the embodiment.

FIG. 4 is a diagram showing an example of a display window of a program according to the embodiment.

FIG. 5 is a flow chart illustrating a conventional video program making method.

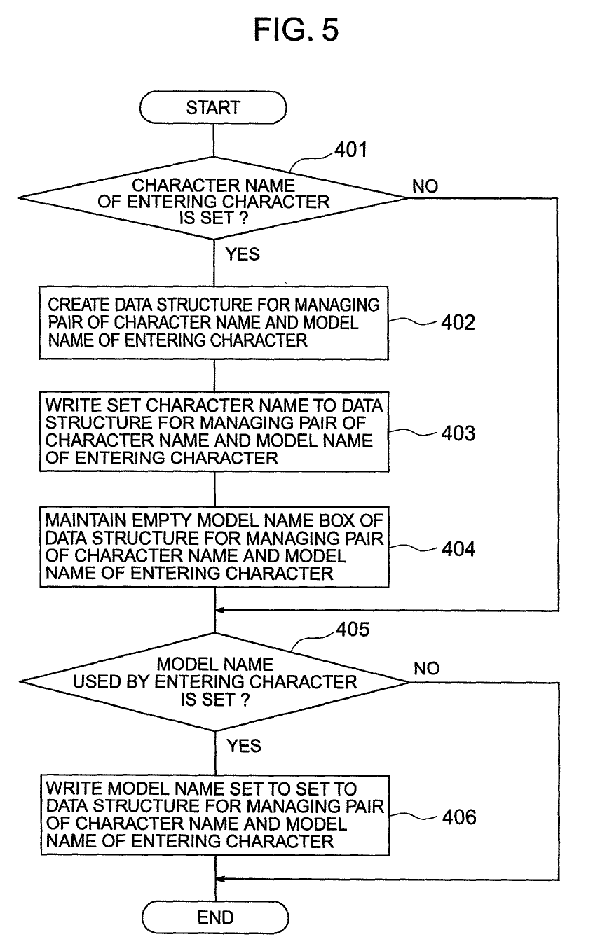

FIG. 6 is a diagram showing an example of a program when a character name and a model name are correctly written in program data.

FIG. 7 is a diagram showing an example of an edit window to be operated in order to make a program as if a scenario is written.

FIGS. 8A to 8E show examples of contents of a character management data structure.

FIG. 9 shows an example of contents of an initialize file.

FIG. 10 shows an input screen when a CG object is a property.

### DESCRIPTION OF THE EMBODIMENTS

A video program making method according to an embodiment of the invention will be described in detail with reference to the accompanying drawings.

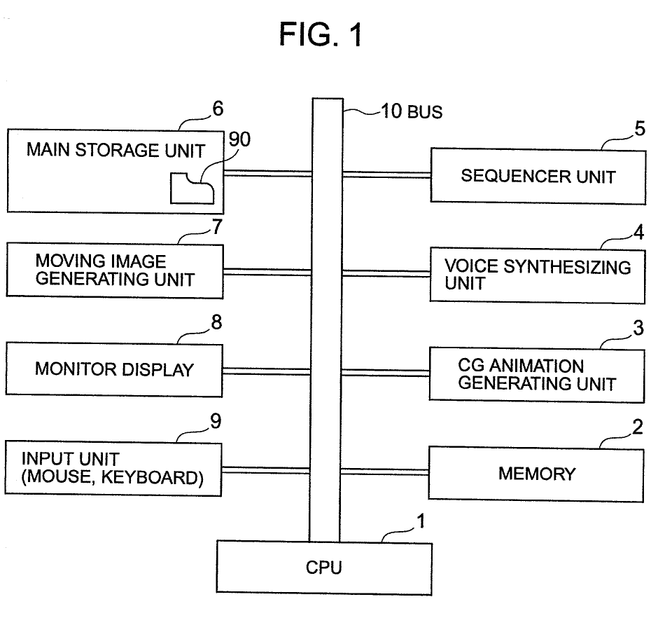

In this embodiment, TVML is used. First, a TV program making apparatus to be used by the video program making method of the embodiment will be described with reference to FIG. 1.

Referring to FIG. 1, a main storage unit 6 is used for storing various CG objects, an application program for executing program creation, and program data including video and audio data obtained during program creation and a completed program. A CG animation generating unit 3 generates animation of a selected CG object. A memory 2 stores events to be adopted. A voice synthesizing unit 4 synthesizes speeches and the like of each character. A moving image generating unit 7 reproduces a pre-edited moving image. A sequencer unit 5 generates a TV program by controlling the main storage unit 6, moving image generating unit 7 and voice synthesizing unit 4 in accordance with events stored in the memory 2. An input unit 9 such as a mouse and a keyboard is used for GUI operations. A monitor 8 displays windows for edit operations and images obtained during program creation. A CPU 1 controls each of the units described above in accordance with the application program. A bus 10 interconnects the above-described constituent elements of the apparatus.

CG objects which enter animation generated by the CG animation generating unit 3 include characters, properties, studio sets and the like selected from various objects stored in the main storage unit 6. Speeches of a character synthesized by the voice synthesizing unit 4 include scenario, cry, pseudo sound, studio effect sound and the like. If a plurality of different languages are used in a program, a plurality of voice synthesizing units 4 may be provided.

Each event stored in the memory 2 indicates each of operations and speeches of an entering character corresponding to a scenario of a TV program. Each event also indicates the contents and timings of moving image reproduction and audio reproduction.

By using the input unit 9, a display instruction for the monitor 8, a reproduction instruction for sequencer unit 5, and an instruction for editing event information of a TV program stored in the memory 2 are entered.

Upon reception of these instructions, CPU 1 controls each of the above-described constituent elements in accordance with the program edit information stored in the memory 2. A magnetic disk apparatus capable of random access is used as the main storage unit 6. An optical disk apparatus, a magneto optical disk apparatus or the like may also be used, or a remote file may be used via a transmission network.

In addition to the constituent elements of the apparatus, another apparatus may be connected to the bus 10. CPU 1 transfers signals to and from the constituent elements and other apparatus to control these elements and apparatus by using access signals.

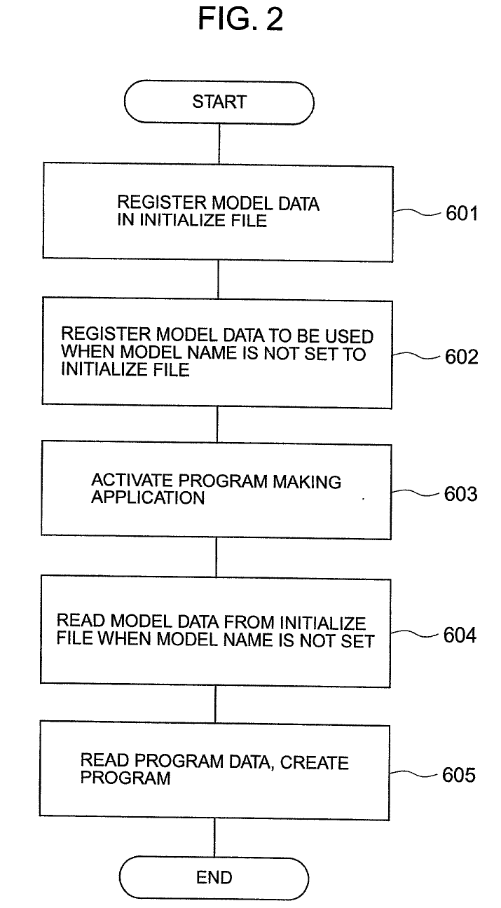

An example of the procedure from model data setting to image data generation of a CG animation program to be executed by selecting CG characters (This means image source materials.) from CG objects according to the embodiment will be described with reference to FIG. 2.

Prior to activating a TV program making application program, various models usable by a CG character are registered. This registration is made by writing the model data in an initialize file of the main storage unit 6 (Step 601).

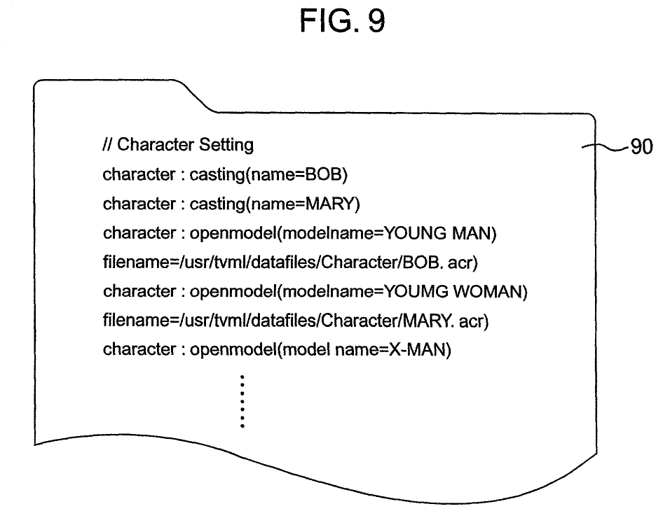

According to the embodiment, in order to write a series of events constituting a program, a virtual model or phantom model is prepared which is used when the model name is not set. The phantom model is a image source material. In this embodiment, the phantom model is named “X-MAN”. The model data of “X-MAN” is then written in the initialize file (Step 602). FIG. 9 shows an example of the initialize file. In the example shown in FIG. 9, two model names to be used with the characters “YOUNG MAN” AND “YOUNG WOMAN” and the phantom model “X-MAN” are registered in the initialize file 90. The computer which performs registration in the initialize file 90 at Steps 601 and 602 may be different from the computer which performs execution of an actual program making program at Steps 603 to 605. The computer which performs execution of the program making program is required to store the initialize file 90 in its memory or to read it from an external storage unit.

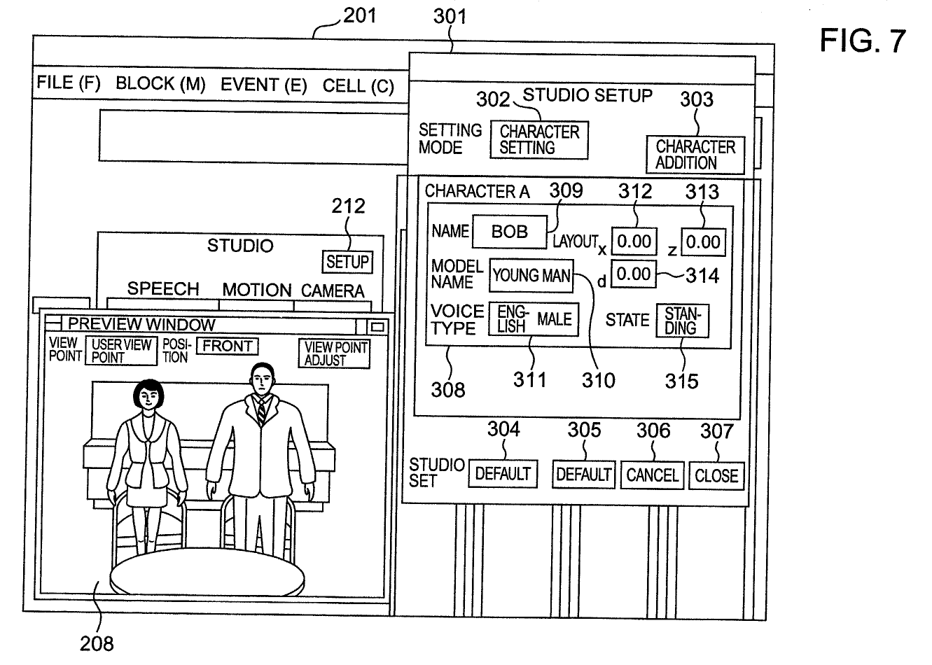

The TV program creation application by TVML is activated (Step 603). As the user sets character data from the character board 308 shown in FIG. 7, the initialize file 90 written with the model data of the character is read into the memory 2 by a copy process (Step 604). The memory 2 recognizes that the model data of “X-MAN” written in the initialize file is stored in the main storage unit 6.

In this embodiment, two characters enter, one having the character name “BOB” and the model name “YOUNG MAN” and the other having the character name “MARY” and the model name “YOUNG WOMAN”. The program using the two characters are created by sequentially writing events, and the creation results are stored as the program data in the main storage unit 6 (Step 605) to thereby complete the program (Step 605).

The procedure of setting a character and its model to be used in the program during the program creation process, i.e., during the program data read process, will be described.

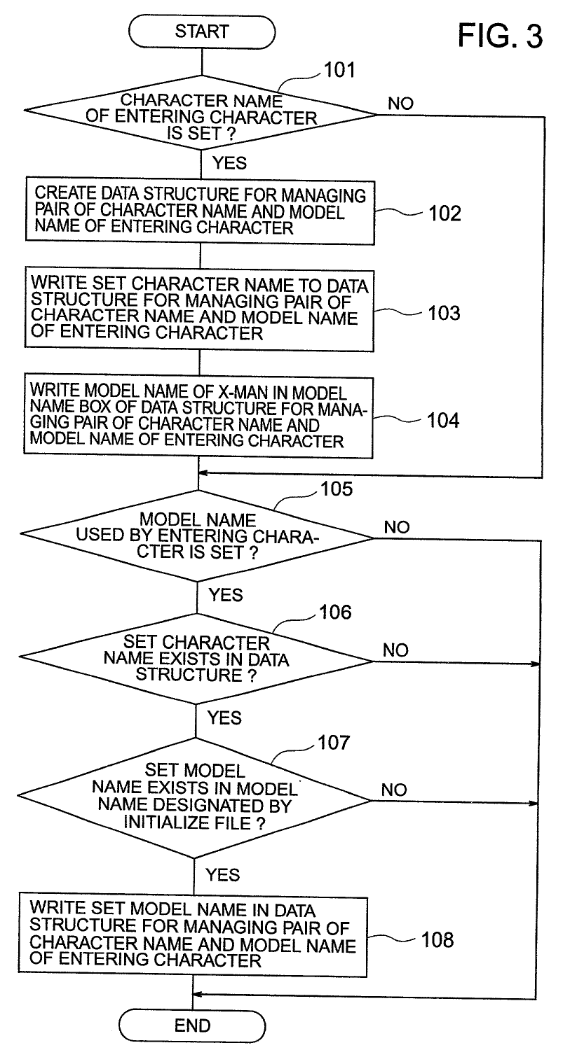

FIG. 3 is a flow chart illustrating an example of the procedure to be executed at Step 605 shown in FIG. 2 by the TV program making apparatus in order to set the CG character to be used by the program.

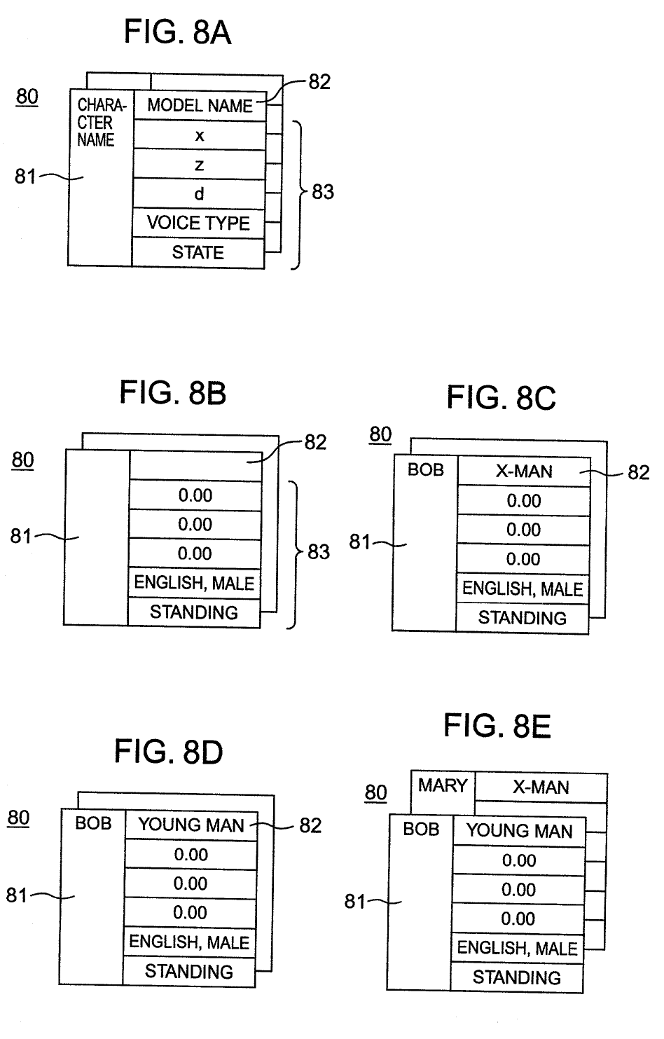

In the procedure of setting a character entering the program, it is first checked whether the character name of the character used by the program is set (Step 101). In this example, “BOB” and “MARY” are set. When the character names are set, the data structure shown in FIG. 8B for managing the character used by the program making apparatus is generated and stored in the memory 2 (Step 102). In the character management data structure 80 generated at Step 102, the character name box 81 and model name box 82 are still empty although the other boxes 83 are written with default initial values.

This data structure 80 can record a pair of the character name and model name. In this embodiment, “BOB” is written as the character name to be set to the character name box 81 of the data structure 80 (Step 103). At this time, the model is not still set to the model name box 82. In this embodiment of the invention, however, irrespective of whether the model name is actually set to the model name box 310 of the character board 308, at the time of Step 103 it is intentionally assumed at the time of Step 103 that the model name is not set, and the phantom model “X-MAN” in the memory 2 to be used when the model name is not set is written as shown in FIG. 8C (Step 104).

At the next stage, the user deletes “X-MAN” written in the model name box 310 of the character board 308 and a correct model name is overwritten and set. It is checked whether the model name to be used by the character is set (Step 105). In this embodiment, the model name used by the character “BOB” is “YOUNG MAN”.

It is checked whether the character name “BOB” used by the set model name “YOUNG MAN” exists in the data structure 80 (FIG. 8C) in the memory 2 (Step 106). If the character name “BOB” is written in the data structure 80, it is checked whether the model name set to the data structure 80 belonging to the character name corresponds to a model usable by the character (whether the model name is registered in the initialize file 90) (Step 107).

If it is judged at Steps 106 and 107 that the character name and model name can be used by the program, as shown in FIG. 8D “YOUNG MAN” is overwritten to the phantom model name “X-MAN” set to the model name box 82 recorded as the pair of the character name “BOB” in the data structure acquired from the character name at Step 106 (Step 108).

The above procedures are performed also for the character “MARY” having the model name “YOUNG WOMAN”.

With the above operations, two data structures for managing the entering characters are generated. One data structure is written with the character name “BOB” and model name “YOUNG MAN”, whereas the other data structure is written with the character name “MARY” and model name “YOUNG WOMAN”. With this setting, the program data with two entering characters is created.

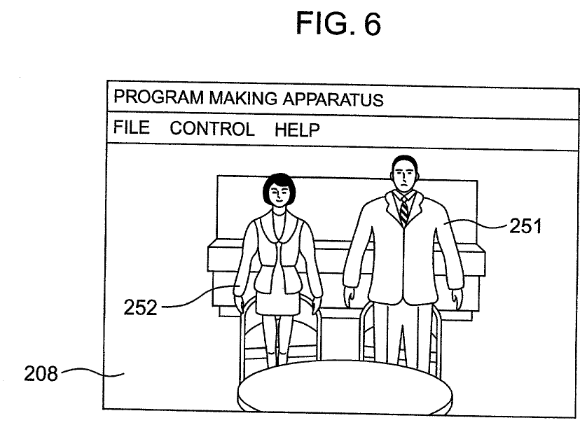

In reproducing the created program, the model data of the model name “YOUNG MAN” of the character name “BOB” is read from the data structure 80 (FIG. 8D) in the memory 2 for managing the character, and loaded from the main storage unit 6 into the memory 2. In response to an instruction from the sequencer unit 5, the character having the model name “YOUNG MAN” is displayed on the monitor 8. Similarly, the character having the character name “MARY” and model name “YOUNG WOMAN” is displayed on the monitor 8. The displayed characters are shown in FIG. 6.

Another procedure according to the embodiment will be described which is performed when a correct model name is not set because the user does not set the model name, erroneously sets the model name, or intentionally sets a wrong model name.

For example, consider the case wherein although two character names “BOB” and “MARY” were set, only one model name “YOUNG MAN” used by the character name “BOB” was set.

Similar processes described above are performed for the character name “BOB”.

For the character name “MARY”, as shown in FIG. 3, it is first checked whether the character name used by the program is set from the character board 308 (Step 101). In this example, the character name “MARY” is set. If the character name “MARY” is set, the data structure for managing a character entering the program is generated in the memory 2 (Step 102). The set character name, in this example, “MARY”, is written in the character name box of the data structure (Step 103). At this time, since the model to be used cannot be recognized, the phantom model “X-MAN” in the initialize file 90 in the memory 2 to be used when the model name is not set, is written in the model name box (Step 104).

Next, it is checked whether the model name used by the character is set (Step 105). The process is terminated because the model name for the character name “MARY” is not set.

Two data structures for managing entering characters are therefore generated as shown in FIG. 8E, one data structure being written with the character name “BOB” and model name “YOUNG MAN” and the other data structure being written with the character name “MARY” and the model name “X-MAN”. With these settings, the program data for the two entering characters is created.

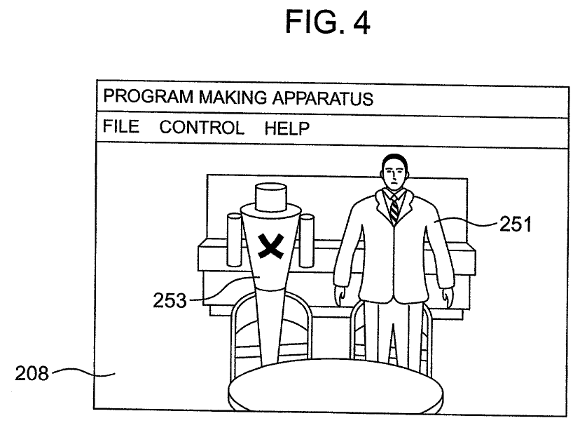

In reproducing the created program, the model data of the model name “YOUNG MAN” of the character name “BOB” is read from the data structure 80 (FIG. 8E) in the memory 2 for managing the character, and loaded from the main storage unit 6 into the memory 2. In response to an instruction from the sequencer unit 5, the character having the model name “YOUNG MAN” is displayed on the monitor 8 in accordance with the data in the memory 2. For the character name “MARY”, the model data of the model name “X-MAN” is loaded from the main storage unit 6 into the memory 2. In response to an instruction from the sequencer unit 5, an image 253 of “X-MAN” is displayed on the monitor 8. The images displayed on the monitor are as shown in FIG. 4.

As the user looks at this screen, it is possible to notice that the character on the left side is unusual and different from the correct model of the initially intended character “MARY”, in the case that the user forgets to set the model name. It is therefore possible to intuitively recognize that the program data has an error in the model name setting part.

Also in the case that the model name was erroneously set, the same results as those of the case that the model name was not set are obtained. For example, it is judged at Step 107 that the set model name is not registered in the initialize file, i.e., the set model is not usable. Therefore, the process is terminated without performing any operation to maintain the state written with “X-MAN” as shown in FIG. 8E. In this manner, the same results as those of the case that the model name was not set are obtained.

If the character name is not set initially, as shown in FIG. 3, the flow skips from Step 101 to Step 105 so that the data structure is not generated nor the model name is set to advance to the next program creation using a different CG object. An image of the model “X-MAN” is like a human figure in the example shown in FIG. 4. In order to make the user recognize the erroneous model, it is preferable to use an image capable of immediately discriminating from other normal characters. If an image can make the user recognize an abnormal model of the CG object, the image of the model X-MAN may be replaced with an alarm by a literal notation other than a human figure, or a special icon alarm.

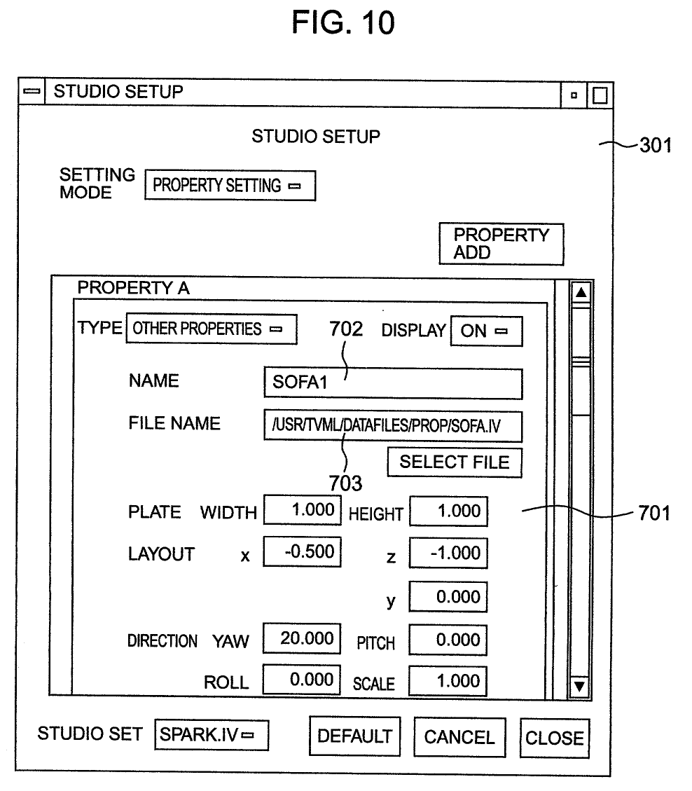

In this embodiment, although characters are entered in CG animation, other,CG objects than characters may be entered in CG animation, such as properties, sets, cameras and lighting. Similar to the character, such CG objects having specific models may be prepared. Also in such cases, the embodiment method of the invention is applicable. Forgetting setting or erroneous setting can therefore be intuititively recognized. FIG. 10 shows an example of a studio setup window for setting properties as the CG objects. A unique name of a property corresponding to a character name is set to a box 702 of a property setting board 701, and a model name for designating the model of a property is set to a box 703. The property CG object of the studio setup window shown in FIG. 10 is a chair. The process to be executed when the model name is not set to the box 703 or when it is erroneously set, is basically the same as that described with reference to FIG. 3. In this case, in place of the chair property, a CG object of the false model is displayed.

According to the invention, when a model name is written to display the character entering an animation image, even if the model name is not set or it is erroneously set, a false character to be used when the model name is not set is displayed. Accordingly, it becomes easy for the user to recognize an error of the program data in the model setting part so that the TV program creation efficiency can be improved.

It should be further understood by those skilled in the art that the foregoing description has been made on embodiments of the invention and that various changes and modifications may be made in the invention without departing from the spirit of the invention and the scope of the appended claims.

What is claimed is:

1. Method of making a video program, comprising the steps of:
recording data about at least individual names, shapes and motions in connection with at least two objects appearing on said video program in a recording device, one of said objects being image source material of said video program, and the other object being a phantom image source material of said video program;
in making said video program, designating said objects used in said video program;
reading out data relating to said objects from said recording device; and
making said video program based on said data read out from said recording device.

2. Method of making a video program according to claim 1, further comprising the step of designating said individual name of said object and a model name for defining said shape and motion in association with said individual name.

3. Method of making a video program according to claim 2, further comprising the step of when said designated model name in association with said individual name of said object has not registered in said recording device, said designated model name is registered as a new model name of said object.

4. Method of making a video program according to claim 1, wherein said object is at least one of the image source materials including a human, a property, a scene, an animal, a camera and a lighting instrument appearing or used in said video program.

5. Method of making a video program according to claim 3, further comprising the step of changing the model name of the object of said phantom image source material to another model name registered in said recording device after a setting of a model name of said object.

6. Method of making a video program, comprising the steps of:
recording data about individual names in connection with at least two objects, model names in connection with said individual names and motions in connection with said model names in a recording device, one of said objects being image source material of said video program, and the other object being a phantom image source material of said video program;
judging whether said individual name of said object is input;
generating a data structure for setting the model name of said object and data corresponding to said model name with respect to said individual name of said object used in said video program;
judging whether said model name corresponding to said individual name of said object is input;
when said model name of said object of said phantom image source material is input, changing said model name of said object of said phantom image source material to newly registered model name; and
making said video program based on said individual name, model name and the data corresponding thereof set in said data structure.

7. Method of making a video program according to claim 6, wherein said object is at least one of the image source materials including a human, a property, a scene, an animal, a camera and a lighting instrument appearing or used in said video program.
